(19) United States
(12) Patent Application Publication
(10) Pub. No.: US 2002/0122525 A1
(43) Pub. Date: Sep. 5, 2002

(54) Removal and collection of particulate from water filled tanks

(76) Inventors: Stefan Rosenberger, Lexington, SC (US); Kent Forrester, Irmo, SC (US); Howard Whitehead, Columbia, SC (US); James H. Wilson, Columbia, SC (US)

Correspondence Address: MICHAEL A MANN, NEXSEN PRUET JACOBS & POLLARD LLP, PO DRWR 2426, COLUMBIA, SC, 29202-2426, US

(21) Appl. No.: 09/917,355

(22) Filed: Jul. 27, 2001

Related U.S. Application Data
(60) Provisional application No. 60/221,075, filed on Jul. 27, 2000.

(51) Int. Cl. G21C 19/00

(52) U.S. Cl. 376/272

(57) ABSTRACT

A system and method for removing and collecting particulate from a water-filled tank using a filter and a pump wherein the pump operates at low flow rate to maintain only a small pressure drop across the filter low. By maintaining a small pressure drop, particulate agglomeates and can load the filter to a greater extent than when the flow rate is higher. The filter may then be crushed and placed into a disposal container for disposal. In an alternate embodiment, the particles can be accumulated in several mesh filters operating at a higher flow rate and then, as each filter is loaded, the filtrate can be back flushed to a second filter operating at low flow rate. The first filters can be repeatedly reused and the second filters can be crushed and placed in a disposal container.

### PRIORITY CLAIM

The Applicants claim the benefit of the filing of U.S. provisional patent application serial No.60/221,075, filed Jul. 7, 2000, which is incorporated herein by reference.

### FIELD OF THE INVENTION

The present invention relates generally to the removal and collection of debris, particulate and crud from water-filled tanks such as spent fuel storage pools at a nuclear power plant.

### BACKGROUND OF THE INVENTION

There are numerous examples in industrial applications of tanks or pools that contain water. One such example is a spent nuclear fuel storage pool. This type of pool is designed to hold racks for storage of both fresh and spent nuclear fuel and other reactor components. When the nuclear reactor is refueled, the fresh fuel replaces a portion of the spent fuel in the reactor core and the spent fuel from the core is stored in the spent fuel storage pool. During refueling, the spent fuel pool is in fluid communication with the reactor vessel, and both the pool and the core as well as the area above the core are kept flooded with water. The water serves two functions. It acts as a radiation shield between the highly radioactive spent fuel and those who are refueling the core and as a coolant to absorb the heat of the radioactively decaying isotopes in the spent fuel.

During routine operation of the power plant, this water will pick up contaminants, crud, and particulate. Herein the word “particulate” will be used to refer to any solids, whether suspended or settled in a tank of water.

The water in this system must be kept clean for a number of reasons. First, murky water obscures the view of the fuel being moved creating uncertainty in handling operations. Also, water that is murky as a result of contaminants creates a level of radioactive exposure to employees managing the fuel and component transfer operations because the particulate itself may be radioactive. Federal law and good operational practices require that radioactive exposure of employees be kept as low as reasonably achievable and thereby mandates the removal of the particulate. Finally, particulate, if not collected for removal can be redistributed throughout the plant where it can adversely affect the operational life of equipment such as pumps and valves.

Typically, particulate is removed from the water of a spent fuel pool by pumping it through cartridge filters. In so far as a way to remove particulate from the pool, this method works well. However, there are problems associated with these filters. First, the filters are made of metal, paper and polymeric materials. Paper and polymers are not stable when exposed to radioactive materials particularly hot materials and tend to break down and emit gases. Second, they require additional handling that increases exposure to radiation. Third, they add considerable volume to the quantity of material to be disposed of and thus increase the cost of disposal. Therefore, there is a need for a better way to remove particulate from water storage tanks such as spent nuclear fuel pools that is effective but which also reduces exposure and overall cost.

### SUMMARY OF THE INVENTION

According to its major aspects and briefly recited, the present invention is a method and system for removing particulate from water-filled tanks such as radioactive material storage pools and collecting it for disposal. The method removes particulate from the water in the tank and tank surfaces by directing a flow of water through a metal mesh filter positioned in the tank. The filter traps quantities of particulate and is then placed in a disposal container, preferably after being crushed to reduce its volume. The filter and container, as well as associated pumping equipment, are kept under water throughout the particulate removal and collection operations to minimize personnel exposure.

Importantly, the flow of water directed through the mesh filter is maintained at a reduced pressure so that the pressure drop across the filter is very low. Accordingly, the particulate tends to agglomerate and cake onto the filter so that the filtrate itself becomes part of the filter.

An important feature of the present invention is the use of a metal mesh filter. Although these filters are much more expensive than conventional, paper-based, cartridge filters, they are stable in a radioactive environment. Second, they can filter a significant loading of particulate and then be crushed so that many more filters can fit into a disposal container or in the “dead space” at the top of a container holding other materials destined for disposal. By substituting metal mesh filters, overall disposal costs and handling considerations are thereby reduced.

The use of low flow rates through metal mesh filters is another important aspect of the present invention. Low flow rates allow the filters to be loaded to a much greater extent before they are blinded by particulate than can be achieved by higher flow rates. The particulate agglomerates and adds to the filtering process, making it more efficient at accumulating particulate, particularly smaller particulate, without immediately blinding the metal mesh.

Crushing of the filters is another important advantage of the present invention. Although metal mesh filters are relatively expensive compared to cartridge filters, the disposal volume saved more than overcomes the disadvantage the higher cost. The fact that it can be crushed reduces the volume to be disposed of by at least a factor of 10:1. The fact that it is stable removes a concern with radioactive waste disposal of traditional paper cartridge filters.

Other features and their advantages will be apparent to those skilled in the art of decontamination and cleaning of nuclear facilities from a careful reading of the Detailed Description of Preferred Embodiments, accompanied by the following drawings.

### BRIEF DESCRIPTION OF THE DRAWINGS

In the drawings:

FIG. 1 is a schematic drawing of a radioactive material storage pool particulate removal system according to a preferred embodiment of the present invention; and

FIG. 2 is a side view of a vacuum head of a radioactive material storage pool particulate removal system according to a preferred embodiment of the present invention.

### DETAILED DESCRIPTION OF PREFERRED EMBODIMENTS

The present invention is a method and system for removal and collection of particulate from the water-filled tanks. This invention will be described in the context of the removal of particulate suspended in the water of and on the surfaces of a spent nuclear fuel pools. However, it will be clear that the present system is not confined to spent nuclear fuel storage pools but may be used in any industrial tanks to remove particulate.

“System” means a collection of components that cooperate to achieve a desired result but which are not necessarily physically connected or closely positioned.

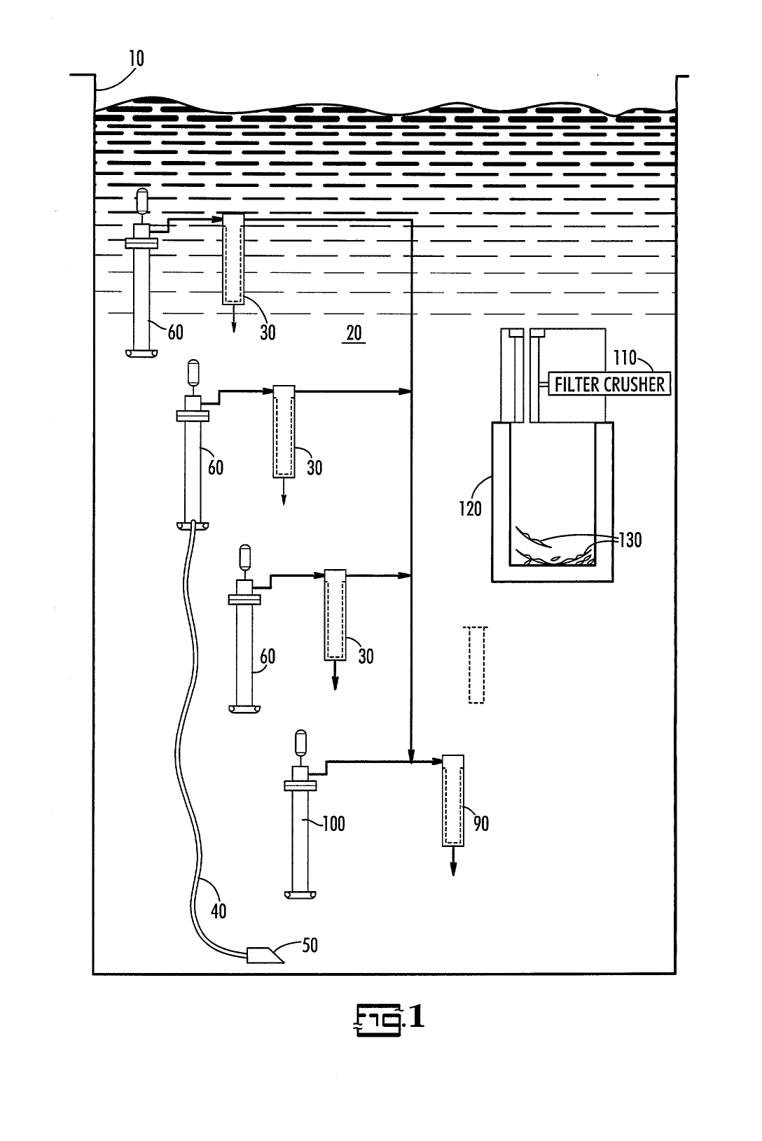

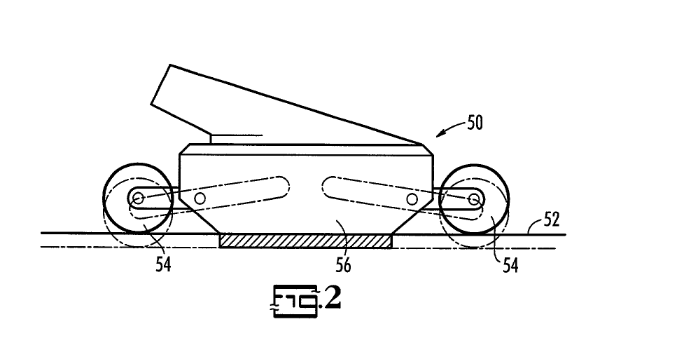

Referring now to FIGS. 1 and 2, there is illustrated the present system and method, respectively. The environment of use in this preferred embodiment is a spent nuclear fuel pool 10 for storing nuclear fuel submerged under a large quantity of water 20. In this preferred embodiment of the present invention, there are one or more first filters 30, at least one of which is connected to a vacuum head 50 via a vacuum hose 40 and a first pump 60. The suction provided by first pump 60 may be divided among the first filters 30, thus reducing the flow rate through each, or each first filter 30 may have its own first pump 60, as shown in FIG. 1, but wherein each first pump 60 is operating at a low head.

Pump 60 creates suction at vacuum head 50 sufficient to gather particulate from the surface 70 of the wall 80 that defines fuel pool 10. The power of first pump 60 should be sufficient to remove particulate.

Vacuum head 50, as shown in detail in FIG. 2, which is optional for cleaning suspended particulate but essential for cleaning surfaces, is designed to permit its elevation above a surface 52 to be varied. This is simply achieved by providing for an adjustment of the stand-off distance between its wheels 54 and surface 52, thereby lowering or raising its body 56. When body 56 is lowered, the velocity of the fluid sucked into vacuum head 50 increases, which allows it to pull in particulate with greater force.

As first filter 30 accumulates particulate, it will become less and less effective because of the pressure drop across it caused by the mass of particulate. At an arbitrary drop in pressure from nominal, fill pressure, the flow through first filter 30 is reversed briefly—giving rise to a puff of water through filter 30 in the reverse direction—to back flush particulate from first filter 30. The back flush of water with entrained and concentrated particulate is directed to a second filter 90 by a second pump 100 operating at low pressure. The flow rate across second filter 90 is maintained at a very low level. When second filter 90 becomes blinded by repeated back flushing of one or more first filters 30, filter 90 and its filtrate will be transferred to a filter crusher 110. Filter crusher 110 will crush second filter 90 and place it into a shielded disposal container 120 suitable for holding and transporting several crushed second filters 130. Alternatively, if other material is being collected and placed in a disposal container for disposal, one or more crushed second filters 90 may be placed in the dead-space near the top of the disposal container to fill it completely. First filters 30, meanwhile, may be reused repeatedly

The pressure drop across second filter 90 is maintained very low so that the waste particles will be able to interact as they approach the mesh barrier of second filter 90. These particulate will tend to agglomerate and form a relatively low density cake on the mesh barrier that itself tends to trap other and smaller particles. The filtrate agglomerates also permit the flow of water through it so that the loading of particulate on second filter 90 can be much greater.

If the flow rate across first filter 30 is relatively higher, and if there are plural first filters 30 for each second filter 90, then the pool 10 can be cleaned quickly. Relatively larger volumes of water and square feet of surface area of pool 10 can be processed. As each first filter 30 is loaded with particulate, it can be back flushed in sequence to one second filter 90.

First and second pumps 60, 100, operate at two different flow rate levels, a low flow rate, such as 5 gpm for vacuuming particulate into first filters, and a higher flow rate, such as 200 gpm for back flushing particulate to second filters 90. Preferably several first filters 30 feed one second filter 90. Most preferably four first filters 30 feed one second filter 90. Meanwhile, all first and second filters 30, 90, and first pumps 60 and second pumps 100 are located underwater so that the water shields the operators.

In an alternative embodiment, a submersible pump pumps the tank water directly into several second filters 90 at low pressure to remove particulate in the spent fuel pool water. Eventually, all the second filters 90 blind and can then be crushed, deposited into a disposal container for shipment. A new set of second filters 90 takes their place, and so on, until the spent fuel pool is sufficiently clean.

Preferably, first and second filters 30, 90, are made of the same material, namely, a material that is stable with respect to the particulate being removed and the environment of use both in the pool and subsequently. For example, first and second filters 30, 90, are preferably made of stainless steel, but may also be made of another stable metal (titanium) or ceramic. Metal mesh filter elements, including those that are pleated or augmented with a non-woven metal “wool” readily give up entrained particulate by back flushing, are easily crushed to reduce their volume by at least 10:1 (and may be inserted into what would otherwise be void spaces in other loads so that they require no additional disposal volume), are sturdy enough for repeated use, and are stable. Although metal mesh filters are known in other applications, where the filter is to be reused, it is believed that use in filtering radioactive particulate is heretofore unknown.

Two basic filter elements can be used in the present system. Both are stainless steel blocking filters. One is a non-woven, “wool” type which requires structural support and the other is a screen-type which is free-standing. Generally, a mesh size of three microns and higher is satisfactory but should be adjusted depending on particle size. In general, the mesh size should be approximately the same size or smaller than the particle size for effective filtration and back flushing.

A number of manufacturers make suitable filters, filter housings and filter elements. For example, filters and filter housings made by Ronningen-Petter Engineered Filtered Systems are satisfactory, as are filter elements made by Fairey Microfiltrex, Inc.

In use, the present method comprises the steps of establishing a flow of water from a vacuum head to a first filter via a vacuum hose; vacuuming particulate from a surface using the vacuum head; back washing the first filter to a second filter; crushing the second filter once it has been loaded with particulate from repeated back washings from the first filter; depositing the crushed second filter in to a disposal container. Preferably all operations, including especially crushing and depositing, take place underwater. The disposal container is then vacuum dried to reduce moisture content.

The effluent from these processes, water from which most of the particulate has been removed, can be returned to the pool, passed through ion exchange resin, or processed in other ways, if desired, to remove dissolved contaminants.

When several first filters are used, they can be back washed in sequence to the second filter so that the utilization of each is maximized—no one first filter is waiting on another first filter to be back washed.

In an alternate embodiment, only second filters 90 are used to clean water 20 in pool 10. A second pump 100 is set to operate a flow rate that, when divided among plural second filters 90 will result in the low flow rate—i.e., 20 gpm—suitable for achieving the agglomeration of particles. As each second filter 90 becomes loaded with particulate, it is crushed by filter crusher 110 and loaded into container 120.

It will be apparent to those skilled in the art of processing particulate in water-filled tanks that many modifications and substitutions may be made to the preferred embodiments described above without departing from the spirit and scope of the invention, defined by the appended claims.

What is claimed is:

1. A system for removing particulate from a water-filled tank, said system comprising:
a first pump;
a first filter in fluid communication with said first pump, said first filter receiving fluid pumped by said pump, said first filter adapted to remove particulate from said fluid;
a second pump; and
a second filter in fluid communication with said second pump and said first filter, said second pump pumping particulate from said first filter to said second filter.

2. A method for decontaminating the surfaces of a spent fuel pool, said method comprising the steps of:
vacuuming particulate from a surface;
filtering said particulate using a first filter;
back flushing said particulate said first filter periodically;
pumping said back flushed particulate to a second filter;
crushing said second filter; and
storing said crushed second filter in a storage container.
